(19) United States
(12) Patent Application Publication
(10) Pub. No.: US 2019/0220411 A1
(43) Pub. Date: Jul. 18, 2019

(54) EFFICIENT PARTITIONING FOR BINNING LAYOUTS

(71) Applicant: QUALCOMM Incorporated, San Diego, CA (US)

(72) Inventors: Aditya Nellutla, Hyderabad (IN); Anoop Kumar Yerukala, Hyderabad (IN)

(21) Appl. No.: 15/873,632

(22) Filed: Jan. 17, 2018

(51) Int. Cl. G06F 12/0846; G06F 9/50; G06T 1/60; G06T 15/00

(52) U.S. Cl. CPC G06F 12/0848; G06F 9/5077; G06T 15/08; G06T 15/005; G06T 1/60

(57) ABSTRACT

Generally, the described techniques provide for efficiently partitioning a frame into bins. For example, a device may identify a size of a cache and determine dimensions of a frame. The device may divide the frame into a first region and a second region that is separate from the first region. The device may then divide the first region into a plurality of bins that have a first vertical dimension and a first horizontal dimension (or varying vertical and/or horizontal dimensions) and divide the second region into one or more bins, where at least one bin has a second vertical dimension that is greater than the first vertical dimension or a second horizontal dimension that is greater than the first horizontal dimension. The device may render the frame using the plurality of bins and the one or more bins. By efficiently partitioning the frame, rendering performance may be improved.

### BACKGROUND

The following relates generally to rendering, and more specifically to efficient partitioning for binning layouts.

A device that provides content for visual presentation on an electronic display generally includes a graphics processing unit (GPU). The GPU in conjunction with other components renders pixels that are representative of the content on the display. That is, the GPU generates one or more pixel values for each pixel on the display and performs graphics processing on the pixel values for each pixel on the display to render each pixel for presentation.

For example, the GPU may convert two-dimensional or three-dimensional virtual objects into a two-dimensional pixel representation that may be displayed. Converting information about three-dimensional objects into a bitmap that can be displayed is known as pixel rendering and requires considerable memory and processing power. Three-dimensional graphics accelerators are becoming increasingly available in devices such as personal computers, smartphones, tablet computers, etc. Such devices may in some cases have constraints on computational power, memory capacity, and/or other parameters. Accordingly, three-dimensional graphics rendering techniques may present difficulties when being implemented on these devices. Improved rendering techniques may be desired.

### SUMMARY

The described techniques relate to improved methods, systems, devices, or apparatuses that support efficient partitioning for binning layouts. Generally, the described techniques provide for efficiently partitioning a frame or render target to improve utilization of local memory associated with a GPU. For example, a device may divide a frame or render target into an internal region and a boundary region. The internal region may comprise a portion of the frame or render target that may be divided into a plurality of bins such that no partial bins exist after bin subdivision in the internal region. That is, each bin of the internal region may have a size equal to (e.g., or nearly equal to) the size of the local memory. The boundary region may comprise a remainder of the frame or render target that is not classified as the internal region. The boundary region may be divided into bins in the horizontal and vertical directions increase utilization of the local memory. By efficiently partitioning the frame or render target, the number of load and store operations associated with the rendering may be reduced, thereby improving rendering performance (e.g., by reducing power consumption without impacting the rendering quality). In some cases, the reduction in the number of load and store operations may be achieved based at least in part on rendering one region, such as the boundary region (e.g., or a portion thereof), directly onto system memory, which may be referred to in some examples as direct rendering. That is, rather than using local memory to render the boundary region, a GPU may be operable to use a direct rendering mode to reduce load and store operations associated with the boundary region. For example, during a binning pass a GPU may identify that the size of the boundary region (e.g., or some similar metric) falls beneath a threshold. This threshold may represent the point at or near which the time saved by loading and storing data for the boundary region via local memory (e.g., which may allow the GPU to access the data quickly) exceeds the time required to operate on the data directly in the system memory. Additional factors for operating in a direct rendering mode for the boundary region may additionally or alternatively be considered (e.g., factors including a power level of the device performing the rendering, a throughput requirement for the rendering operation, a number of primitives visible in the boundary region).

A method of rendering is described. The method may include identifying a size of a cache of the device, determining dimensions of a frame, dividing, based at least in part on the determined dimensions and the size of the cache, the frame into a first region and a second region that is separate from the first region, dividing the first region into a plurality of bins that each have a first vertical dimension and a first horizontal dimension, dividing the second region into one or more bins, at least one bin of the one or more bins having a second vertical dimension that is greater than the first vertical dimension or a second horizontal dimension that is greater than the first horizontal dimension, and rendering the frame using the plurality of bins and the one or more bins.

An apparatus for rendering is described. The apparatus may include means for identifying a size of a cache of the device, means for determining dimensions of a frame, means for dividing, based at least in part on the determined dimensions and the size of the cache, the frame into a first region and a second region that is separate from the first region, means for dividing the first region into a plurality of bins that each have a first vertical dimension and a first horizontal dimension, means for dividing the second region into one or more bins, at least one bin of the one or more bins having a second vertical dimension that is greater than the first vertical dimension or a second horizontal dimension that is greater than the first horizontal dimension, and means for rendering the frame using the plurality of bins and the one or more bins.

Another apparatus for rendering is described. The apparatus may include a processor, memory in electronic communication with the processor, and instructions stored in the memory. The instructions may be operable to cause the processor to identify a size of a cache of the device, determine dimensions of a frame, divide, based at least in part on the determined dimensions and the size of the cache, the frame into a first region and a second region that is separate from the first region, divide the first region into a plurality of bins that each have a first vertical dimension and a first horizontal dimension, divide the second region into one or more bins, at least one bin of the one or more bins having a second vertical dimension that is greater than the first vertical dimension or a second horizontal dimension that is greater than the first horizontal dimension, and render the frame using the plurality of bins and the one or more bins.

A non-transitory computer-readable medium for rendering is described. The non-transitory computer-readable medium may include instructions operable to cause a processor to identify a size of a cache of the device, determine dimensions of a frame, divide, based at least in part on the determined dimensions and the size of the cache, the frame into a first region and a second region that is separate from the first region, divide the first region into a plurality of bins that each have a first vertical dimension and a first horizontal dimension, divide the second region into one or more bins, at least one bin of the one or more bins having a second vertical dimension that is greater than the first vertical dimension or a second horizontal dimension that is greater than the first horizontal dimension, and render the frame using the plurality of bins and the one or more bins.

In some examples of the method, apparatus, and non-transitory computer-readable medium described above, dividing the second region into the one or more bins includes dividing the second region into a first bin having the second vertical dimension and a second bin having the second horizontal dimension.

In some examples of the method, apparatus, and non-transitory computer-readable medium described above, the second vertical dimension may be different from the second horizontal dimension.

In some examples of the method, apparatus, and non-transitory computer-readable medium described above, dividing the second region into the one or more bins includes dividing the second region into a first bin having the second vertical dimension and a second bin having the second vertical dimension. Additionally or alternatively, dividing the second region into the one or more bins may include dividing the second region into a third bin having the second horizontal dimension and a fourth bin having the second horizontal dimension.

In some examples of the method, apparatus, and non-transitory computer-readable medium described above, dividing the second region into the one or more bins includes dividing the second region into a first bin having the second vertical dimension and a second bin, where a sum of a vertical dimension of the second bin and the second vertical dimension may be greater than or equal to a total vertical dimension of the frame.

In some examples of the method, apparatus, and non-transitory computer-readable medium described above, dividing the second region into the one or more bins includes dividing the second region into a first bin having the second horizontal dimension and a second bin, where a sum of a horizontal dimension of the second bin and the second horizontal dimension may be greater than or equal to a total horizontal dimension of the frame.

In some examples of the method, apparatus, and non-transitory computer-readable medium described above, dividing the frame into a first region and a second region includes classifying the first region as an internal region and the second region as an edge region that may be directly adjacent to the internal region on at least two sides.

In some examples of the method, apparatus, and non-transitory computer-readable medium described above, dividing the second region into the one or more bins comprises: dividing the second region in a vertical direction, a horizontal direction, or both to increase a utilization of the cache.

In some examples of the method, apparatus, and non-transitory computer-readable medium described above, dividing the frame into the first region and the second region occurs concurrently with dividing the first region into the plurality of bins, or dividing the second region into the one or more bins, or both.

In some examples of the method, apparatus, and non-transitory computer-readable medium described above, each bin of the one or more bins may have a size that may be smaller than the size of the cache.

In some examples of the method, apparatus, and non-transitory computer-readable medium described above, dividing the first region into the plurality of bins includes dividing the first region such that a size of each of the plurality of bins after the dividing may be less than or equal to the size of the cache.

In some examples of the method, apparatus, and non-transitory computer-readable medium described above, a size of the first region may be greater than a size of the second region.

Some examples of the method, apparatus, and non-transitory computer-readable medium described above may further include processes, features, means, or instructions for performing a visibility pass operation for the frame, wherein the determining the dimensions of the frame may be based at least in part on the visibility pass operation.

In some examples of the method, apparatus, and non-transitory computer-readable medium described above, rendering the frame includes loading each bin of the plurality of bins and each bin of the one or more bins from the cache. Some examples of the method, apparatus, and non-transitory computer-readable medium described above may further include processes, features, means, or instructions for executing one or more rendering commands for each loaded bin. Some examples of the method, apparatus, and non-transitory computer-readable medium described above may further include processes, features, means, or instructions for storing a result of the one or more rendering commands for each bin in a display buffer.

Some examples of the method, apparatus, and non-transitory computer-readable medium described above may further include processes, features, means, or instructions for executing one or more rendering commands to render at least a subset of the one or more bins directly on a system memory of the apparatus

In some examples of the method, apparatus, and non-transitory computer-readable medium described above, the dimensions of the frame may be equal to a size of the first region plus a size of the second region.

### BRIEF DESCRIPTION OF THE DRAWINGS

FIG. 1 illustrates an example of a system for rendering that supports efficient partitioning for binning layouts in accordance with aspects of the present disclosure.

FIG. 2 illustrates an example of a frame that supports efficient partitioning for binning layouts in accordance with aspects of the present disclosure.

FIGS. 3A and 3B illustrate example bin partitions, aspects of which support efficient partitioning for binning layouts in accordance with aspects of the present disclosure.

FIGS. 4 and 5 show block diagrams of a device that supports efficient partitioning for binning layouts in accordance with aspects of the present disclosure.

FIG. 6 illustrates a block diagram of a GPU that supports efficient partitioning for binning layouts in accordance with aspects of the present disclosure.

FIG. 7 illustrates a block diagram of a device that supports efficient partitioning for binning layouts in accordance with aspects of the present disclosure.

FIGS. 8 through 10 illustrate methods for efficient partitioning for binning layouts in accordance with aspects of the present disclosure.

### DETAILED DESCRIPTION

Some GPU architectures may require a relatively large amount of data to be read from and written to system memory when rendering a frame of graphics data (e.g., an image). Mobile architectures (e.g., GPUs on mobile devices) may lack the memory bandwidth capacity required for processing entire frames of data. Accordingly, bin-based architectures may be utilized to divide an image into multiple bins (e.g., tiles). The tiles may be sized so that they can be processed using a relatively small amount (e.g., 256 kilobytes (kB)) of high bandwidth, on-chip graphics memory (which may be referred to as a cache, a GPU memory, or a graphics memory (GMEM) in aspects of the present disclosure). That is, the size of each bin may depend on or be limited by the size of the cache. The image may be reconstructed after processing each bin.

Bin rendering may thus be described with respect to a number of processing passes. For example, when performing bin-based rendering, a GPU may perform a binning pass and a plurality of rendering passes. With respect to the binning pass, the GPU may process an entire image and sort rasterized primitives (such as triangles) into bins. For example, the GPU may process a command stream for an entire image and assign the rasterized primitives of the image to bins.

In some examples, the GPU may generate one or more visibility streams during the binning pass (e.g., which may alternatively be referred to as a visibility pass operation herein). A visibility stream indicates the primitives that are visible in the final image and the primitives that are invisible in the final image. For example, a primitive may be invisible if it is obscured by one or more other primitives such that the primitive cannot be seen in the final reconstructed image. A visibility stream may be generated for an entire image, or may be generated on a per bin basis (e.g., one visibility stream for each bin). Generally, a visibility stream may include a series of bits, with each “1” or “0” being associated with a particular primitive. Each “1” may, for example, indicate that the primitive is visible in the final image, while each “0” may indicate that the primitive is invisible in the final image. In some cases, the visibility stream may control the rendering pass. For example, the visibility stream may be used to forego the rendering of invisible primitives. Accordingly, only the primitives that actually contribute to a bin (e.g., that are visible in the final image) are rendered and shaded, thereby reducing rendering and shading operations.

In other examples, the GPU may use a different process (e.g., other than or in addition to the visibility streams described above) to classify primitives as being located in a particular bin. In another example, a GPU may output a separate list per bin of “indices” that represent only the primitives that are present in a given bin. For example, the GPU may initially include all the primitives (e.g., vertices) in one data structure. The GPU may generate a set of pointers into the structure for each bin that only point to the primitives that are visible in each bin. Thus, certain pointers for visible indices may be included in a per-bin index list. Such pointers may serve a similar purpose as the visibility streams described above, with the pointers indicating which primitives (and pixels associated with the primitives) are included and visible in a particular bin.

A GPU may render graphics data using one or more render targets. In general, a render target may relate to a buffer in which the GPU draws pixels for an image being rendered. Creating a render target may involve reserving a particular region in memory for drawing. In some instances, an image may be composed of content from a plurality of render targets. For example, the GPU may render content to a number of render targets (e.g., offscreen rendering) and assemble the content to produce a final image (also referred to as a scene). Render targets may be associated with a number of commands. For example, a render target typically has a width (e.g., a horizontal dimension) and a height (e.g., a vertical dimension). A render target may also have a surface format, which describes how many bits are allocated to each pixel and how they are divided between red, green, blue, and alpha (e.g., or another color format). The contents of a render target may be modified by one or more rendering commands, such as commands associated with a fragment shader. In some examples, a render target or a frame may be divided in various bins or tiles. That is, a render target (e.g., a color buffer, a depth buffer, a texture) or a frame (e.g., the graphics data itself) may be divided into bins or tiles for processing.

In some cases, a GPU may use a cache (e.g., a fixed local memory) to perform tile-based rendering. The tile-based rendering may include dividing the scene geometry in a frame into bins, which are then processed using respective load and store operations. For example, the division into bins may be based on the display or render target resolution (e.g., including color/depth/stencil buffers). Generally, the frame may be divided into fixed-sized tiles which fit into the local memory. However, in some cases the bin dimensions may not exactly align with the frame or render target dimensions, leaving partially fragmented bins at the edge boundary of the frame or render target. These partially fragmented bins limit the efficiency of the rendering operation (e.g., by leading to more bins, which in turn cause a larger number of load and store operations), which may be problematic (e.g., for devices with limited processing resources). In accordance with aspects of the present disclosure, a device may efficiently partition a frame into bins so as to improve utilization of the local memory and thereby increase efficiency of the rendering operation. Additionally or alternatively, a device may perform direct rendering for at least some of the partially fragmented bins. Such direct rendering may remove the need to perform load and store operations for the partially fragmented bins (e.g., by allowing the device to render the bins directly on a system memory).

Aspects of the disclosure are initially described in the context of a wireless communications system. Aspects of the disclosure are further illustrated by and described with reference to apparatus diagrams, system diagrams, and flowcharts that relate to efficient partitioning for binning layouts.

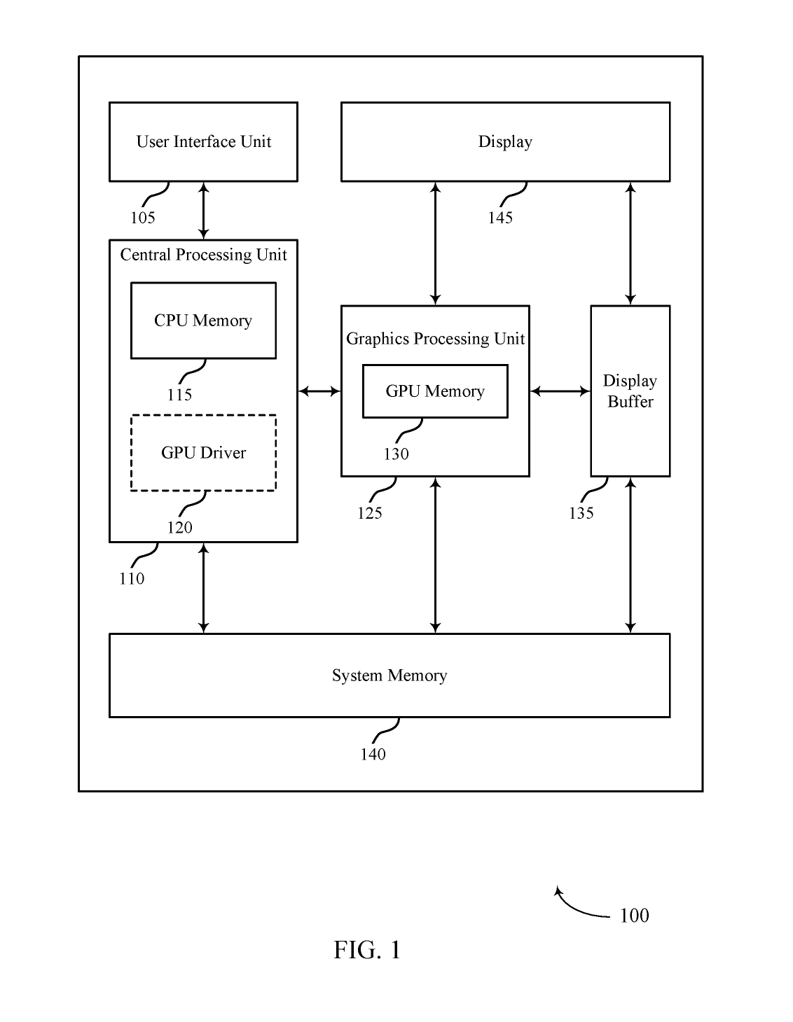

FIG. 1 illustrates an example of a device 100 in accordance with various aspects of the present disclosure. Examples of device 100 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 1, device 100 includes a central processing unit (CPU) 110 having CPU memory 115, a GPU 125 having GPU memory 130, a display 145, a display buffer 135 storing data associated with rendering, a user interface unit 105, and a system memory 140. For example, system memory 140 may store a GPU driver 120 (illustrated as being contained within CPU 110 as described below) having a compiler, a GPU program, a locally-compiled GPU program, and the like. User interface unit 105, CPU 110, GPU 125, system memory 140, and display 145 may communicate with each other (e.g., using a system bus).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and GPU 125 are illustrated as separate units in the example of FIG. 1, in some examples, CPU 110 and GPU 125 may be integrated into a single unit. CPU 110 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 145. As illustrated, CPU 110 may include CPU memory 115. For example, CPU memory 115 may represent on-chip storage or memory used in executing machine or object code. CPU memory 115 may include one or more volatile or non-volatile memories or storage devices, such as flash memory, a magnetic data media, an optical storage media, etc. CPU 110 may be able to read values from or write values to CPU memory 115 more quickly than reading values from or writing values to system memory 140, which may be accessed, e.g., over a system bus.

GPU 125 may represent one or more dedicated processors for performing graphical operations. That is, for example, GPU 125 may be a dedicated hardware unit having fixed function and programmable components for rendering graphics and executing GPU applications. GPU 125 may also include a DSP, a general purpose microprocessor, an ASIC, an FPGA, or other equivalent integrated or discrete logic circuitry. GPU 125 may be built with a highly-parallel structure that provides more efficient processing of complex graphic-related operations than CPU 110. For example, GPU 125 may include a plurality of processing elements that are configured to operate on multiple vertices or pixels in a parallel manner. The highly parallel nature of GPU 125 may allow GPU 125 to generate graphic images (e.g., graphical user interfaces and two-dimensional or three-dimensional graphics scenes) for display 145 more quickly than CPU 110.

GPU 125 may, in some instances, be integrated into a motherboard of device 100. In other instances, GPU 125 may be present on a graphics card that is installed in a port in the motherboard of device 100 or may be otherwise incorporated within a peripheral device configured to interoperate with device 100. As illustrated, GPU 125 may include GPU memory 130. For example, GPU memory 130 may represent on-chip storage or memory used in executing machine or object code. GPU memory 130 may include one or more volatile or non-volatile memories or storage devices, such as flash memory, a magnetic data media, an optical storage media, etc. GPU 125 may be able to read values from or write values to GPU memory 130 more quickly than reading values from or writing values to system memory 140, which may be accessed, e.g., over a system bus. That is, GPU 125 may read data from and write data to GPU memory 130 without using the system bus to access off-chip memory. This operation may allow GPU 125 to operate in a more efficient manner by reducing the need for GPU 125 to read and write data via the system bus, which may experience heavy bus traffic.

Display 145 represents a unit capable of displaying video, images, text or any other type of data for consumption by a viewer. Display 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of imagery, such as computer-generated graphics, still images, video frames, or the like for display 145. Display buffer 135 may represent a two-dimensional buffer that includes a plurality of storage locations. The number of storage locations within display buffer 135 may, in some cases, generally correspond to the number of pixels to be displayed on display 145. For example, if display 145 is configured to include 640×480 pixels, display buffer 135 may include 640×480 storage locations storing pixel color and intensity information, such as red, green, and blue pixel values, or other color values. Display buffer 135 may store the final pixel values for each of the pixels processed by GPU 125. Display 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110. Examples of user interface unit 105 include, but are not limited to, a trackball, a mouse, a keyboard, and other types of input devices. User interface unit 105 may also be, or include, a touch screen and the touch screen may be incorporated as part of display 145.

System memory 140 may comprise one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110. Additionally, system memory 140 may store user applications and application surface data associated with the applications. System memory 140 may in some cases store information for use by and/or information generated by other components of device 100. For example, system memory 140 may act as a device memory for GPU 125 and may store data to be operated on by GPU 125 (e.g., in a direct rendering operation) as well as data resulting from operations performed by GPU 125.

In some examples, system memory 140 may include instructions that cause CPU 110 or GPU 125 to perform the functions ascribed to CPU 110 or GPU 125 in aspects of the present disclosure. System memory 140 may, in some examples, be considered as a non-transitory storage medium. The term “non-transitory” should not be interpreted to mean that system memory 140 is non-movable. As one example, system memory 140 may be removed from device 100 and moved to another device. As another example, a system memory substantially similar to system memory 140 may be inserted into device 100. In certain examples, a non-transitory storage medium may store data that can, over time, change (e.g., in RAM).

System memory 140 may store a GPU driver 120 and compiler, a GPU program, and a locally-compiled GPU program. The GPU driver 120 may represent a computer program or executable code that provides an interface to access GPU 125. CPU 110 may execute the GPU driver 120 or portions thereof to interface with GPU 125 and, for this reason, GPU driver 120 is shown in the example of FIG. 1 within CPU 110. GPU driver 120 may be accessible to programs or other executables executed by CPU 110, including the GPU program stored in system memory 140. Thus, when one of the software applications executing on CPU 110 requires graphics processing, CPU 110 may provide graphics commands and graphics data to GPU 125 for rendering to display 145 (e.g., via GPU driver 120).

The GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 125 to execute commands without user knowledge as to the specifics of the hardware components. In order to process the graphics rendering instructions, CPU 110 may issue one or more rendering commands to GPU 125 (e.g., through GPU driver 120) to cause GPU 125 to perform some or all of the rendering of the graphics data. In some examples, the graphics data to be rendered may include a list of graphics primitives (e.g., points, lines, triangles, quadrilaterals, etc.).

The GPU program stored in system memory 140 may invoke or otherwise include one or more functions provided by GPU driver 120. CPU 110 generally executes the program in which the GPU program is embedded and, upon encountering the GPU program, passes the GPU program to GPU driver 120. CPU 110 executes GPU driver 120 in this context to process the GPU program. That is, for example, GPU driver 120 may process the GPU program by compiling the GPU program into object or machine code executable by GPU 125. This object code may be referred to as a locally-compiled GPU program. In some examples, a compiler associated with GPU driver 120 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 110 and GPU 125).

In the example of FIG. 1, the compiler may receive the GPU program from CPU 110 when executing HL code that includes the GPU program. That is, a software application being executed by CPU 110 may invoke GPU driver 120 (e.g., via a graphics API) to issue one or more commands to GPU 125 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 125 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 120 may formulate one or more commands that specify one or more operations for GPU 125 to perform in order to render the primitive. When GPU 125 receives a command from CPU 110, it may decode the command and configure one or more processing elements to perform the specified operation and may output the rendered data to display buffer 135.

GPU 125 generally receives the locally-compiled GPU program, and then, in some instances, GPU 125 renders one or more images and outputs the rendered images to display buffer 135. For example, GPU 125 may generate a number of primitives to be displayed at display 145. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 125 for display as an image (or frame in the context of video data) via display 145. GPU 125 may transform primitives and other attributes (e.g., that define a color, texture, lighting, camera configuration, or other aspect) of the primitives into a so-called “world space” by applying one or more model transforms (which may also be specified in the state data). Once transformed, GPU 125 may apply a view transform for the active camera (which again may also be specified in the state data defining the camera) to transform the coordinates of the primitives and lights into the camera or eye space. GPU 125 may also perform vertex shading to render the appearance of the primitives in view of any active lights. GPU 125 may perform vertex shading in one or more of the above model, world, or view space.

Once the primitives are shaded, GPU 125 may perform projections to project the image into a canonical view volume. After transforming the model from the eye space to the canonical view volume, GPU 125 may perform clipping to remove any primitives that do not at least partially reside within the canonical view volume. That is, GPU 125 may remove any primitives that are not within the frame of the camera. GPU 125 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 125 may then rasterize the primitives. Generally, rasterization may refer to the task of taking an image described in a vector graphics format and converting it to a raster image (e.g., a pixelated image) for output on a video display or for storage in a bitmap file format.

In some examples, GPU 125 may implement tile-based rendering to render an image. For example, GPU 125 may implement a tile-based architecture that renders an image or rendering target by breaking the image into multiple portions, referred to as tiles or bins. The bins may be sized based on the size of GPU memory 130 (e.g., which may alternatively be referred to herein as GMEM or a cache). When implementing tile-based rendering, GPU 125 may perform a binning pass and one or more rendering passes. For example, with respect to the binning pass, GPU 125 may process an entire image and sort rasterized primitives into bins. GPU 125 may also generate one or more visibility streams during the binning pass, which visibility streams may be separated according to bin. For example, each bin may be assigned a corresponding portion of the visibility stream for the image. GPU driver 120 may access the visibility stream and generate command streams for rendering each bin. In aspects of the following, a binning pass may alternatively be referred to as a visibility stream operation.

With respect to each rendering pass, GPU 125 may perform a load operation, a rendering operation, and a store operation. During the load operation, GPU 125 may initialize GPU memory 130 for a new bin to be rendered. During the rendering operation, GPU 125 may render the bin and store the rendered bin to GPU memory 130. That is, GPU 125 may perform pixel shading and other operations to determine pixel values for each pixel of the tile and write the pixel values to GPU memory 130. During the store operation, GPU 125 may transfer the finished pixel values of the bin from GPU memory 130 to display buffer 135 (or system memory 140). After GPU 125 has rendered all of the bins associated with a frame (e.g., or a given rendering target) in this way, display buffer 135 may output the finished image to display 145. In some cases, at least some of the bins may be rendered directly on system memory 140 (e.g., before being output to display buffer 135). That is, rather than being loaded from system memory 140 to the GMEM where the GPU 125 can quickly access and operate on the data before storing it to display buffer 135 or back to system memory 140, some bins may be operated on (e.g., by GPU 125) directly in system memory 140. In some such cases, the time (e.g., or processing power) saved by removing the load and store operations may outweigh the time lost by directly rendering in system memory 140 (e.g., rather than in a GMEM).

In accordance with the described techniques, a device such as device 100 may divide a frame or render target into an internal region and a boundary region. The internal region may comprise a portion of the frame or render target that may be divided into a plurality of bins such that no partial bins exist after bin subdivision within the internal region. In some examples, each bin of the internal region may have a size equal to (e.g., or nearly equal to) the size of the local memory, while in other examples at least some bins of the internal region may have a size different from the size of the local memory. The boundary region may comprise a remainder of the frame or render target that is not included in the internal region. The boundary region may be divided into bins in the horizontal direction, the vertical direction, or both to increase utilization of the local memory. By efficiently partitioning the frame or render target, the number of related operations (e.g., load and store operations, such as those by which GPU 125 loads bins to GPU memory 130 and stores rendered data to display buffer 135) associated with the rendering may be reduced, thereby improving rendering performance (e.g., by reducing power consumption without impacting the rendering quality). Additionally or alternatively, device 100 may perform direct rendering for at least some of the partially fragmented bins. Such direct rendering may remove the need to perform load and store operations for the partially fragmented bins (e.g., by allowing the device to render the bins directly on system memory 140).

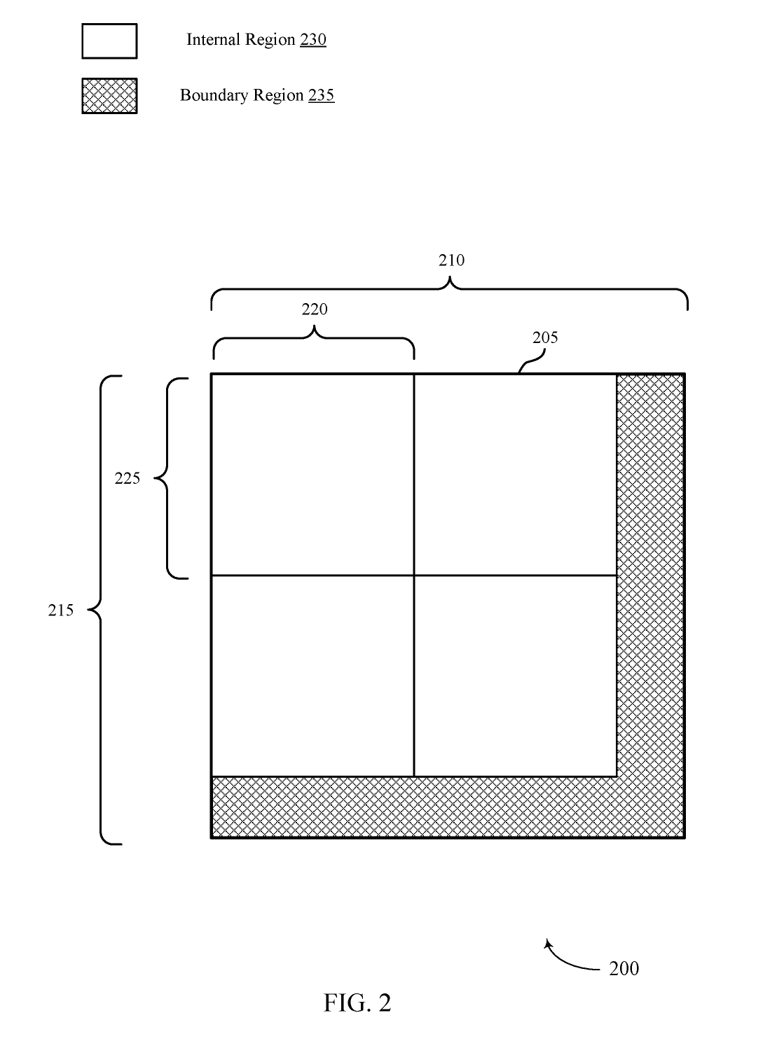

FIG. 2 illustrates an example frame 200 that supports efficient partitioning for binning layouts in accordance with various aspects of the present disclosure. By way of example, frame 200 (which may have a size of 9×9 or 9 units by 9 units, as one example) may be retrieved from a system memory (such as system memory 140) of a device or otherwise triggered by a software application being executed by a device (e.g., by a CPU of the device) and processed to be shown on a display (such as display 145). As illustrated, frame 200 may be divided into a plurality of bins 205 for tile-based rendering.

For example, graphics hardware that processes frame 200 may contain fast memory (e.g., GPU memory 130 described with reference to FIG. 1) that is of a size sufficient to hold a bin 205. As part of a single rendering pass for a particular portion of a frame 200, a GPU (such as GPU 125 described with reference to device 100) may render all or a subset of a batch of primitives with respect to a particular subset of the destination pixels (e.g., a particular bin of destination pixels) of the frame 200. After performing a first rendering pass with respect to a first bin 205, the GPU may store the rendered data in a display buffer and perform a second rendering pass with respect to a second bin 205, and so on. The GPU may incrementally traverse through the bins 205 until the primitives associated with every bin 205 have been rendered before displaying frame 200.

In accordance with aspects of the present disclosure, a device (such as device 100 described with reference to FIG. 1) may divide a first portion of frame 200 into internal region 230 and a second portion of frame 200 into boundary region 235. As illustrated, internal region 230 may be divided into a plurality of bins 205 (e.g., four in the present example), each having a horizontal dimension 220 and a vertical dimension 225. For example, horizontal dimension 220 and vertical dimension 225 may be based on (e.g., limited by) a size of a cache such as GPU memory 130 described with reference to FIG. 1. In some examples, the size of at least some, if not all, of the bins 205 in the internal region (which may have a size of 4 units×4 units, as one example) may be based on (or in some cases may be the same as) a size of the internal cache (which may be 4 units×4 units, as one example), which may be an example of local memory. Though illustrated as being squares, it should be understood that horizontal dimension 220 may in some cases may be different than vertical dimension 225 (e.g., 4 units vs. 6 units, 5 units vs. 7 units, 4 units vs. 8 units). In various examples, the units described for the various dimensions may be pixels, groups of pixels, other lengths, other measurements, etc.

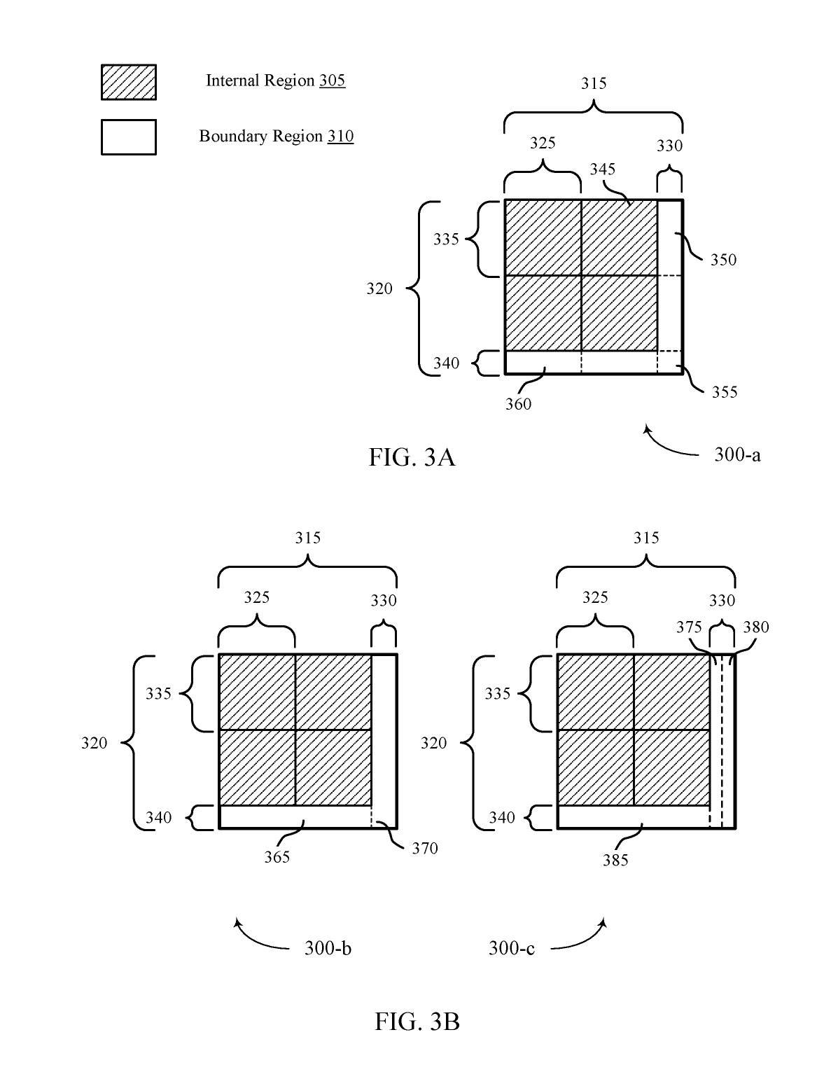

Because frame horizontal dimension 210 is not evenly divisible by horizontal dimension 220, a residual portion (illustrated as boundary region 235) may remain following division of internal region 230 into bins 205. Additionally or alternatively, frame vertical dimension 215 may not be evenly divisible by vertical dimension 225, resulting in a residual portion in the vertical direction. In this example, boundary region 235 may be efficiently partitioned to facilitate the rendering process, as described further below with respect to FIGS. 3A and 3B.

FIG. 3A illustrates an example of a bin partition 300-a. Bin partition 300-a illustrates a frame having frame horizontal dimension 315 (e.g., 9 units) and frame vertical dimension 320 (e.g., 9 units). For example, the frame may be retrieved from a system memory of a device (such as system memory 140 described with reference to FIG. 1) and processed for display. As described with reference to FIG. 2, the frame may be divided into internal region 305 (which may have a total size of 8 units×8 units, for example) and boundary region 310 (which may have a size smaller than internal region 305) during a binning pass performed by a GPU or another component of a device.

Internal region 305 may be divided into a plurality of bins 345 (four in the present example), each having a horizontal dimension 325 (e.g., 4 units) and vertical dimension 335 (e.g., 4 units). Because frame vertical dimension 320 may not be evenly divisible by vertical dimension 335 (e.g., and/or frame horizontal region 315 may not be evenly divisible by horizontal dimension 325), boundary region 310 may exist. As shown, boundary region 310 may have a vertical portion (which may in some examples span at least 4 vertical units if not more) with a horizontal dimension 330 (e.g., 1 unit), which may in some cases be less than horizontal dimension 325 (e.g., 4 units). Additionally or alternatively, boundary region 310 may have a horizontal portion (which may in some examples span at least 4 horizontal units if not more) with a vertical dimension 340 (e.g., 1 unit), which may in some cases be less than vertical dimension 335 (e.g. 4 units).

In some cases, boundary region 310 may be divided based at least in part on vertical dimension 335 and horizontal dimension 325. That is, boundary region may be divided into two horizontal bins 360 each having horizontal dimension 325 (e.g., 4 units) and vertical dimension 340 (e.g., 1 unit), two vertical bins 350 each having vertical dimension 335 (e.g., 4 units) and horizontal dimension 330 (e.g., 1 unit), and one corner bin 355 having vertical dimension 340 (e.g., 1 unit) and horizontal dimension 330 (e.g., 1 unit). Such partitioning may require five load and store operations to process boundary region 310 (e.g., one load and store operation for each bin in boundary region 310).

FIG. 3B illustrates bin partitions 300-b and 300-c that support efficient partitioning for binning layouts in accordance with aspects of the present disclosure. As illustrated, each of bin partition 300-b and 300-c contain an internal region 305 and boundary region 310 as described with reference to FIG. 3A. Further, the internal region 305 may be divided into a plurality of bins 345 for each of bin partition 300-b and 300-c as described with reference to FIG. 3A.

Various configurations for efficiently dividing boundary region 310 to improve utilization of a cache are contemplated in the present disclosure. These techniques generally improve the utilization of the cache by increasing a size of one or more bins of boundary region 310 (e.g., as compared to bin partition 300-a), which in turn decreases the number of bins to be processed and produces a corresponding reduction in a number of load and store operations to be performed by a GPU. Additionally or alternatively, the reduction in load and store operations may be achieved based at least in part on directly rendering boundary region 310 (or a portion thereof) on a system memory of the device. By directly rendering boundary region 310, a device may not need to perform load and store operations for the corresponding bins. Thus, while directly rendering the entire frame may not be feasible (e.g., because of a relatively slower processing capability of a direct rendering mode), directly rendering portions of the frame (e.g., boundary region 310) to reduce a number of load and store operations may improve efficiency of the rendering operation.

It is to be understood that bin partitions 300-b and 300-c are illustrated for the sake of example and are not limiting of the scope of the present disclosure. For example, aspects of bin partitions 300-b and 300-c may be combined and/or divided to produce a different bin partition without deviating from the scope of the present disclosure. Additionally or alternatively, the concepts behind the bin partitioning described with reference to bin partitions 300-b and 300-c may be used to produce other bin partitions without deviating from the scope of the present disclosure.

As illustrated with respect to bin partition 300-b, boundary region 310 may be divided into a horizontal bin 365 having a horizontal dimension (e.g., 8 units, 4 or more units) greater than or equal to horizontal dimension 325. Additionally or alternatively, boundary region 310 may be divided into a vertical bin 370 having a vertical dimension (e.g., 9 units, 4 or more units) greater than or equal to vertical dimension 335. In some cases, each of horizontal bin 365 and vertical bin 370 may have a total size (e.g., 1 unit×8 units and 9 units×1 unit, respectively) that is less than (or equal to) a total size of the internal cache (e.g., 4 units×4 units), which may be an example of local memory. Thus, using bin partition 300-b, boundary region 310 may be processed using two load and store operations (e.g., compared to the five load and store operations required by bin partition 300-a). Thus, if each set of load and store operations requires X cycles to be completed, bin partition 300-b may save a total of 3X cycles compared to bin partition 300-a, which savings may benefit a device in terms of render operation timing and/or power requirements, among other aspects. Additionally or alternatively, at least a subset of at least one of vertical bin 370 or horizontal bin 365 may be rendered directly on a system memory (e.g., which may save a total of 5X cycles compared to bin partition 300-a in the case that both are directly rendered).

In another example illustrated by bin partition 300-c, boundary region may be divided into a horizontal bin 385 having a horizontal dimension (e.g., 8 units, 4 or more units) that is greater than or equal to horizontal dimension 325. Additionally or alternatively, boundary region 310 may be divided into a first vertical bin 375 and a second vertical bin 380, each having a vertical dimension that is greater than or equal to vertical dimension 335. Thus, if each set of load and store operations requires X cycles to be completed, bin partition 300-c may save a total of 2X cycles compared to bin partition 300-a, which savings may benefit a device in terms of render operation timing and/or power requirements. Additionally or alternatively, at least a subset of at least one of first vertical bin 375, second vertical bin 380, or horizontal bin 385 may be rendered directly on a system memory (e.g., which may save a total of 5X cycles compared to bin partition 300-a in the case that all three are directly rendered).

Alternative considerations for bin partitions 300 in accordance with the present disclosure are described. Aspects of these considerations may be combined or omitted from each other. In some cases, boundary region 310 may be divided into multiple vertical bins (e.g., as illustrated with respect to first vertical bin 375 and second vertical bin 380) and/or multiple horizontal bins. In some cases, the multiple vertical bins may have a same size, or they may differ in a vertical dimension, a horizontal dimension, or both. In some cases, the multiple horizontal bins may have a same size, or they may differ in a vertical dimension or a horizontal dimension. In some cases, the multiple vertical bins may be vertically adjacent or horizontally adjacent (e.g., as illustrated with respect to first vertical bin 375 and second vertical bin 380). Similarly, the multiple horizontal bins may be vertically adjacent or horizontally adjacent.

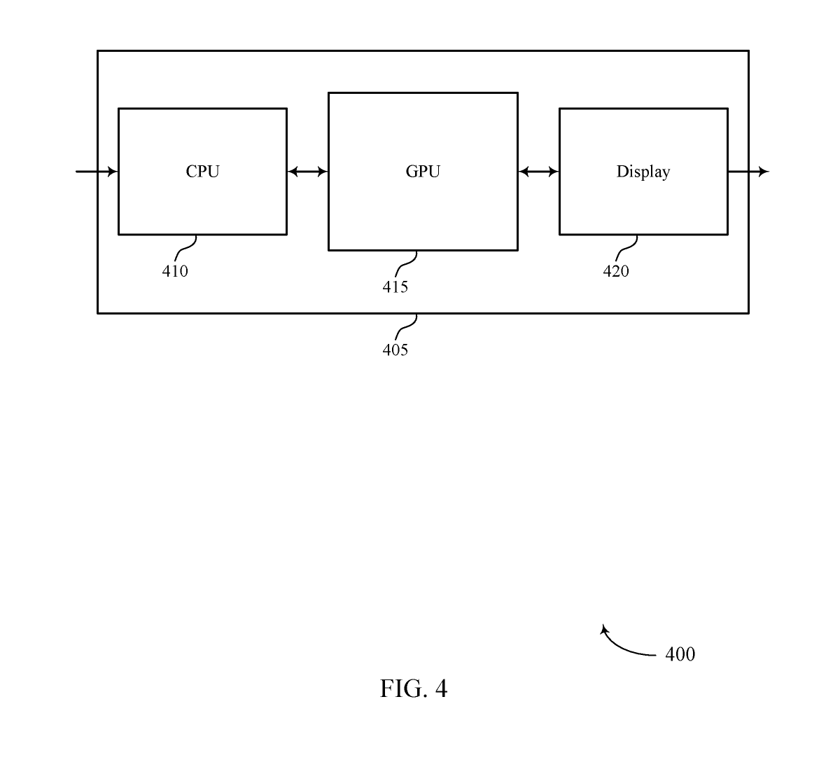

FIG. 4 shows a block diagram 400 of a device 405 that supports efficient partitioning for binning layouts in accordance with aspects of the present disclosure. Device 405 may be an example of aspects of a device 100 as described herein. Device 405 may include CPU 410, GPU 415, and display 420. Each of these components may be in communication with one another (e.g., via one or more buses).

CPU 410 may be an example of CPU 110 described with reference to FIG. 1. CPU 410 may execute one or more software applications, such as web browsers, graphical user interfaces, video games, or other applications involving graphics rendering for image depiction (e.g., via display 420). As described above, CPU 410 may encounter a GPU program (e.g., a program suited for handling by GPU 415) when executing the one or more software applications. Accordingly, CPU 410 may submit rendering commands to GPU 415 (e.g., via a GPU driver containing a compiler for parsing API-based commands).

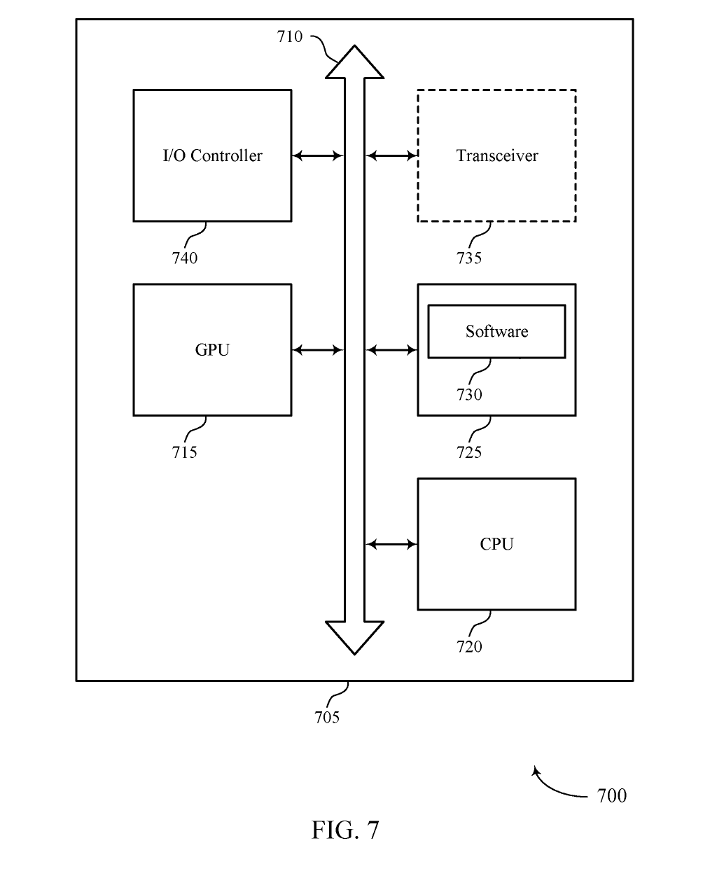

GPU 415 may be an example of aspects of the GPU 715 described with reference to FIG. 7 or the GPU 125 described with reference to FIG. 1. GPU 415 and/or at least some of its various sub-components may be implemented in hardware, software executed by a processor, firmware, or any combination thereof. If implemented in software executed by a processor, the functions of the GPU 415 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

GPU 415 and/or at least some of its various sub-components may be physically located at various positions, including being distributed such that portions of functions are implemented at different physical locations by one or more physical devices. In some examples, GPU 415 and/or at least some of its various sub-components may be a separate and distinct component in accordance with various aspects of the present disclosure. In other examples, GPU 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

GPU 415 may identify a size of a cache of device 405. GPU 415 may determine dimensions of a frame. GPU 415 may divide, based on the determined dimensions and the size of the cache, the frame into a first region and a second region that is separate from the first region. GPU 415 may divide the first region into a set of bins that each have a first vertical dimension and a first horizontal dimension. GPU 415 may divide the second region into one or more bins, at least one bin of the one or more bins having a second vertical dimension that is greater than the first vertical dimension or a second horizontal dimension that is greater than the first horizontal dimension. GPU 415 may render the frame using the set of bins and the one or more bins.

Display 420 may display content generated by other components of the device. Display 420 may be an example of display 145 as described with reference to FIG. 1. In some examples, display 420 may be connected with a display buffer which stores rendered data until an image is ready to be displayed (e.g., as described with reference to FIG. 1).

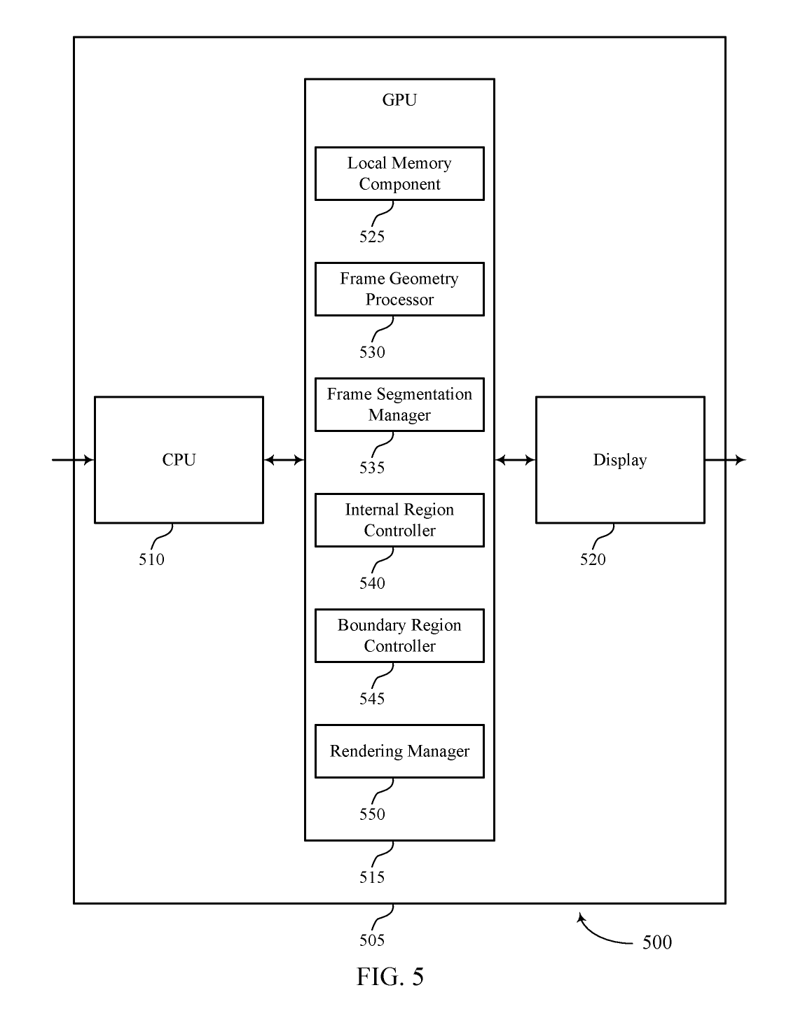

FIG. 5 shows a block diagram 500 of a device 505 that supports efficient partitioning for binning layouts in accordance with aspects of the present disclosure. Device 505 may be an example of aspects of a device 405 as described with reference to FIG. 4 or a device 100 as described with reference to FIG. 1. Device 505 may include CPU 510, GPU 515, and display 520. GPU 515 may also include local memory component 525, frame geometry processor 530, frame segmentation manager 535, internal region controller 540, boundary region controller 545, and rendering manager 550. Each of these components may be in communication with one another (e.g., via one or more buses).

CPU 510 may be an example of CPU 110 described with reference to FIG. 1. CPU 510 may execute one or more software applications, such as web browsers, graphical user interfaces, video games, or other applications involving graphics rendering for image depiction (e.g., via display 520). As described above, CPU 510 may encounter a GPU program (e.g., a program suited for handling by GPU 515) when executing the one or more software applications. Accordingly, CPU 510 may submit rendering commands to GPU 515 (e.g., via a GPU driver containing a compiler for parsing API-based commands).

Local memory component 525 may identify a size of a cache of the device. Frame geometry processor 530 may determine dimensions of a frame.

Frame segmentation manager 535 may divide, based on the determined dimensions and the size of the cache, the frame into a first region and a second region that is separate from the first region. In some cases, dividing the frame into the first region and the second region occurs concurrently with dividing the first region into the set of bins, or dividing the second region into the one or more bins, or both. That is, in some cases, the operations of frame segmentation manager 535 may be performed concurrently with the operations of internal region controller 540 and/or boundary region controller 545 described below.

Thus, in some cases two or more of frame segmentation manager 535, internal region controller 540, and boundary region controller 545 may be or represent aspects of a same component of device 505. In some cases, dividing the frame into a first region and a second region includes classifying the first region as an internal region and the second region as an edge region that is directly adjacent to the internal region on at least two sides. In some cases, a size of the first region is greater than a size of the second region. In some cases, the dimensions of the frame are equal to a size of the first region plus a size of the second region (i.e., the first region and the second region may together make up the entire frame).

Internal region controller 540 may divide the first region into a set of bins that each have a first vertical dimension and a first horizontal dimension. That is, each bin of the set of bins of the first region may have a same size in some examples. In some cases, dividing the first region into the set of bins includes dividing the first region such that a size of each of the set of bins after the dividing is less than or equal to the size of the cache.

Boundary region controller 545 may divide the second region into one or more bins, at least one bin of the one or more bins having a second vertical dimension that is greater than the first vertical dimension or a second horizontal dimension that is greater than the first horizontal dimension. In some cases, boundary region controller 545 may divide the second region into a third bin having the second horizontal dimension and a fourth bin having the second horizontal dimension.

In some cases, dividing the second region into the one or more bins includes dividing the second region into a first bin having the second vertical dimension and a second bin having the second horizontal dimension. In some cases, the second vertical dimension is different from the second horizontal dimension. In some cases, dividing the second region into the one or more bins includes dividing the second region into a first bin having the second vertical dimension and a second bin having the second vertical dimension.

In some cases, dividing the second region into the one or more bins includes dividing the second region into a first bin having the second vertical dimension and a second bin, where a sum of a vertical dimension of the second bin and the second vertical dimension is greater than or equal to a total vertical dimension of the frame.

In some cases, dividing the second region into the one or more bins includes dividing the second region into a first bin having the second horizontal dimension and a second bin, where a sum of a horizontal dimension of the second bin and the second horizontal dimension is greater than or equal to a total horizontal dimension of the frame. In some cases, dividing the second region into the one or more bins includes dividing the second region in a vertical direction, a horizontal direction, or both to increase a utilization of the cache. In some cases, each bin of the one or more bins has a size that is smaller than the size of the cache.

Rendering manager 550 may render the frame using the set of bins and the one or more bins. Rendering manager 550 may load each bin of the set of bins and each bin of the one or more bins from the cache. Rendering manager 550 may execute one or more rendering commands for each loaded bin. Rendering manager 550 may store a result of the one or more rendering commands for each bin in a display buffer. Rendering manager 550 may execute one or more rendering commands for rendering at least a subset of the one or more bins directly on a system memory of device 505.

Display 520 may display content generated by other components of the device. Display 520 may be an example of display 145 as described with reference to FIG. 1. In some examples, display 520 may be connected with a display buffer which stores rendered data until an image is ready to be displayed (e.g., as described with reference to FIG. 1).

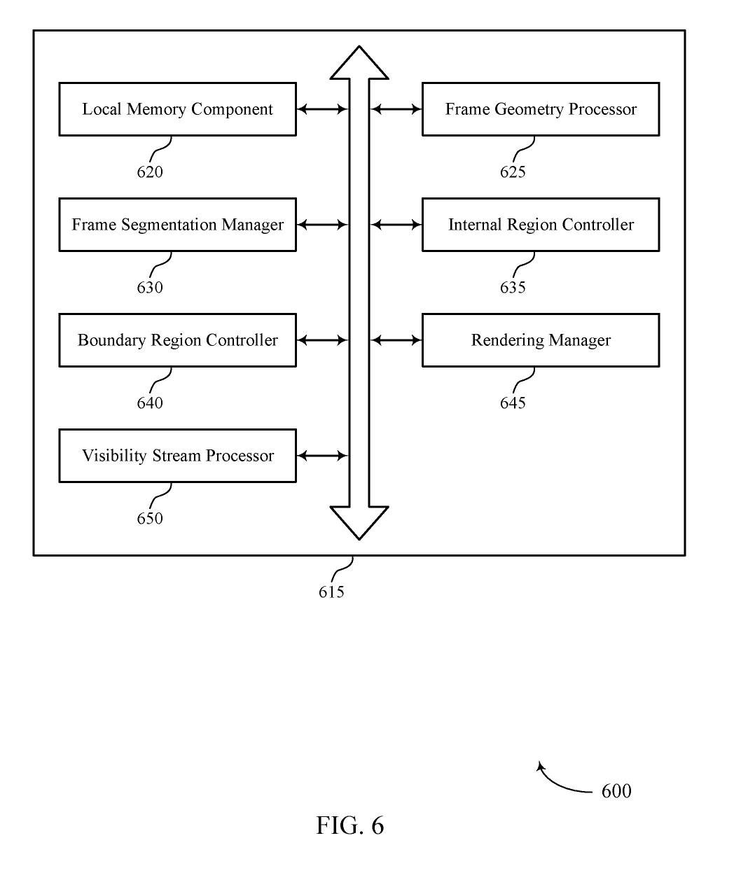

FIG. 6 shows a block diagram 600 of a GPU 615 that supports efficient partitioning for binning layouts in accordance with aspects of the present disclosure. The GPU 615 may be an example of aspects of a GPU 125, a GPU 415, a GPU 515, or a GPU 715 described with reference to FIGS. 1, 4, 5, and 7. GPU 615 may include local memory component 620, frame geometry processor 625, frame segmentation manager 630, internal region controller 635, boundary region controller 640, rendering manager 645, and visibility stream processor 650. Each of these modules may communicate, directly or indirectly, with one another (e.g., via one or more buses).

Local memory component 620 may identify a size of a cache of the device. Frame geometry processor 625 may determine dimensions of a frame.

Frame segmentation manager 630 may divide, based on the determined dimensions and the size of the cache, the frame into a first region and a second region that is separate from the first region. In some cases, dividing the frame into the first region and the second region occurs concurrently with dividing the first region into the set of bins, or dividing the second region into the one or more bins, or both. That is, in some cases, the operations of frame segmentation manager 630 may be performed concurrently with the operations of internal region controller 635 and/or boundary region controller 640 described below.

Thus, in some cases two or more of frame segmentation manager 630, internal region controller 635, and boundary region controller 640 may be or represent aspects of a same component of device. In some cases, dividing the frame into a first region and a second region includes classifying the first region as an internal region and the second region as an edge region that is directly adjacent to the internal region on at least two sides. In some cases, a size of the first region is greater than a size of the second region. In some cases, the dimensions of the frame are equal to a size of the first region plus a size of the second region (i.e., the first region and the second region may together make up the entire frame).

Internal region controller 635 may divide the first region into a set of bins that each have a first vertical dimension and a first horizontal dimension. That is, each bin of the set of bins of the first region may have a same size in some examples. In some cases, dividing the first region into the set of bins includes dividing the first region such that a size of each of the set of bins after the dividing is less than or equal to the size of the cache.

Boundary region controller 640 may divide the second region into one or more bins, at least one bin of the one or more bins having a second vertical dimension that is greater than the first vertical dimension or a second horizontal dimension that is greater than the first horizontal dimension. In some cases, boundary region controller 640 may divide the second region into a third bin having the second horizontal dimension and a fourth bin having the second horizontal dimension. In some cases, dividing the second region into the one or more bins includes dividing the second region into a first bin having the second vertical dimension and a second bin having the second horizontal dimension. In some cases, the second vertical dimension is different from the second horizontal dimension. In some cases, dividing the second region into the one or more bins includes dividing the second region into a first bin having the second vertical dimension and a second bin having the second vertical dimension.

In some cases, dividing the second region into the one or more bins includes dividing the second region into a first bin having the second vertical dimension and a second bin, where a sum of a vertical dimension of the second bin and the second vertical dimension is greater than or equal to a total vertical dimension of the frame.

In some cases, dividing the second region into the one or more bins includes dividing the second region into a first bin having the second horizontal dimension and a second bin, where a sum of a horizontal dimension of the second bin and the second horizontal dimension is greater than or equal to a total horizontal dimension of the frame. In some cases, dividing the second region into the one or more bins includes dividing the second region in a vertical direction, a horizontal direction, or both to increase a utilization of the cache. In some cases, each bin of the one or more bins has a size that is smaller than the size of the cache.

Rendering manager 645 may render the frame using the set of bins and the one or more bins. Rendering manager 645 may load each bin of the set of bins and each bin of the one or more bins from the cache. Rendering manager 645 may execute one or more rendering commands for each loaded bin. Rendering manager 645 may store a result of the one or more rendering commands for each bin in a display buffer. Rendering manager 645 may execute one or more rendering commands for rendering at least a subset of the one or more bins directly on a system memory of a device housing or otherwise interoperable with GPU 615.

Visibility stream processor 650 may perform a visibility pass operation for the frame, where the dimensions of the frame are determined based at least in part on the visibility pass operation.

FIG. 7 shows a diagram of a system 700 including a device 705 that supports efficient partitioning for binning layouts in accordance with aspects of the present disclosure. Device 705 may be an example of or include the components of device 405, device 505, or a device 100 as described above, e.g., with reference to FIGS. 1, 4, and 5. Device 705 may include components for bi-directional voice and data communications including components for transmitting and receiving communications, including GPU 715, CPU 720, memory 725, software 730, transceiver 735, and I/O controller 740. These components may be in electronic communication via one or more buses (e.g., bus 710).

CPU 720 may include an intelligent hardware device, (e.g., a general-purpose processor, a DSP, a microcontroller, an ASIC, an FPGA, a programmable logic device, a discrete gate or transistor logic component, a discrete hardware component, or any combination thereof). In some cases, CPU 720 may be configured to operate a memory array using a memory controller. In other cases, a memory controller may be integrated into CPU 720. CPU 720 may be configured to execute computer-readable instructions stored in a memory to perform various functions (e.g., functions or tasks supporting dynamic bin ordering for load synchronization).

Memory 725 may include RAM and ROM. The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support efficient partitioning for binning layouts. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may, in some examples, represent a wireless transceiver and may communicate bi-directionally with another wireless transceiver. The transceiver 735 may also include a modem to modulate the packets and provide the modulated packets to the antennas for transmission, and to demodulate packets received from the antennas.

I/O controller 740 may manage input and output signals for device 705. I/O controller 740 may also manage peripherals not integrated into device 705. In some cases, I/O controller 740 may represent a physical connection or port to an external peripheral. In some cases, I/O controller 740 may utilize an operating system such as iOS®, ANDROID®, MS-DOS®, MS-WINDOWS®, OS/2®, UNIX®, LINUX®, or another known operating system. In other cases, I/O controller 740 may represent or interact with a modem, a keyboard, a mouse, a touchscreen, or a similar device. In some cases, I/O controller 740 may be implemented as part of a processor. In some cases, a user may interact with device 705 via I/O controller 740 or via hardware components controlled by I/O controller 740. I/O controller 740 may in some cases represent or interact with a display.

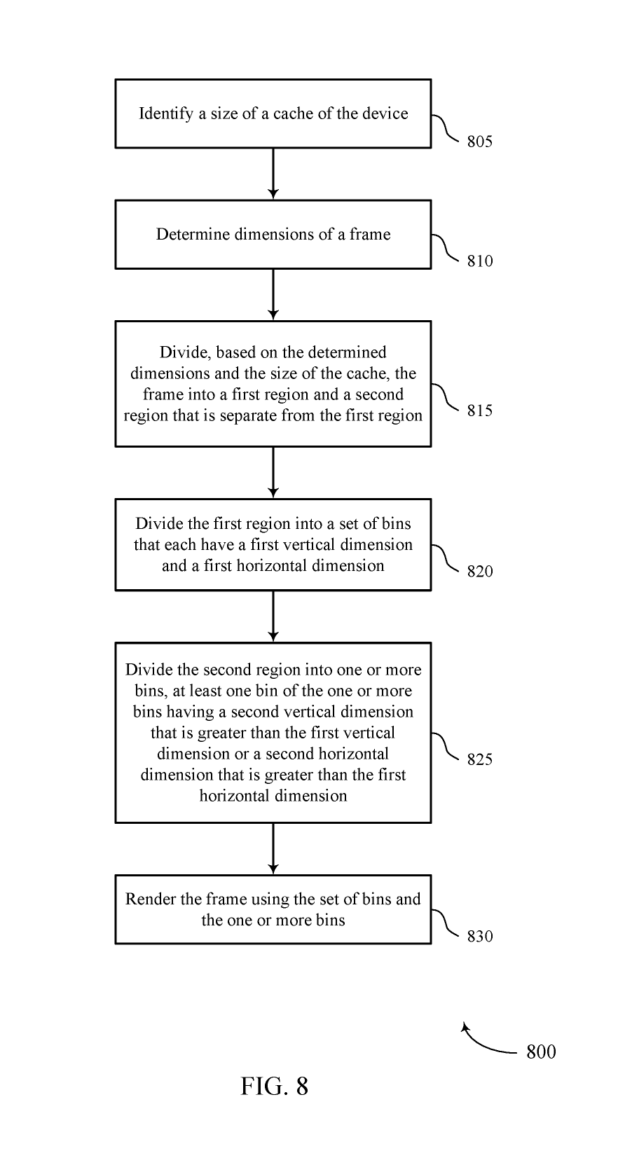

FIG. 8 shows a flowchart illustrating a method 800 for efficient partitioning for binning layouts in accordance with aspects of the present disclosure. The operations of method 800 may be implemented by a device or its components as described herein. For example, the operations of method 800 may be performed by a GPU as described with reference to FIGS. 4 through 7. In some examples, a device may execute a set of codes to control the functional elements of the device to perform the functions described below. Additionally or alternatively, the device may perform aspects of the functions described below using special-purpose hardware.

At 805 the device may identify a size of a cache of the device. The operations of 805 may be performed according to the methods described herein. In certain examples, aspects of the operations of 805 may be performed by a local memory component as described with reference to FIGS. 4 through 7.

At 810 the device may determine dimensions of a frame. The operations of 810 may be performed according to the methods described herein. In certain examples, aspects of the operations of 810 may be performed by a frame geometry processor as described with reference to FIGS. 4 through 7.

At 815 the device may divide, based at least in part on the determined dimensions and the size of the cache, the frame into a first region and a second region that is separate from the first region. The operations of 815 may be performed according to the methods described herein. In certain examples, aspects of the operations of 815 may be performed by a frame segmentation manager as described with reference to FIGS. 4 through 7.

At 820 the device may divide the first region into a plurality of bins that each have a first vertical dimension and a first horizontal dimension. The operations of 820 may be performed according to the methods described herein. In certain examples, aspects of the operations of 820 may be performed by an internal region controller as described with reference to FIGS. 4 through 7.

At 825 the device may divide the second region into one or more bins, at least one bin of the one or more bins having a second vertical dimension that is greater than the first vertical dimension or a second horizontal dimension that is greater than the first horizontal dimension. The operations of 825 may be performed according to the methods described herein. In certain examples, aspects of the operations of 825 may be performed by a boundary region controller as described with reference to FIGS. 4 through 7.

At 830 the device may render the frame using the plurality of bins and the one or more bins. For example, the device may execute one or more rendering commands for at least a subset of the one or more bins directly on a system memory. That is, rather than performing a respective pair of load and store operations for each of the one or more bins, the device may in some cases render at least some of the boundary region bins directly on a system memory. The operations of 830 may be performed according to the methods described herein. In certain examples, aspects of the operations of 830 may be performed by a rendering manager as described with reference to FIGS. 4 through 7.

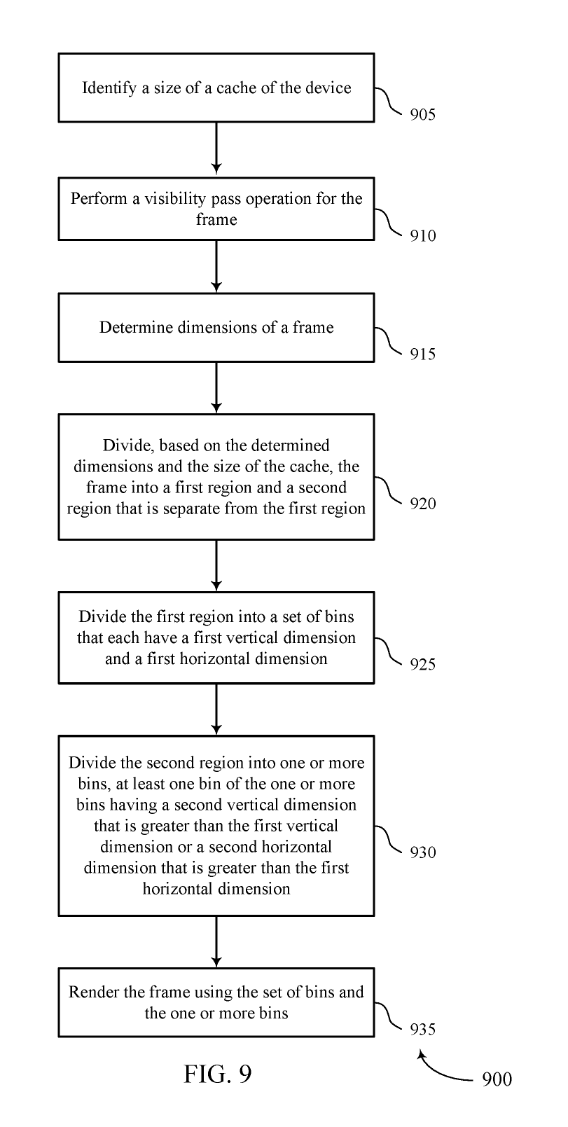

FIG. 9 shows a flowchart illustrating a method 900 for efficient partitioning for binning layouts in accordance with aspects of the present disclosure. The operations of method 900 may be implemented by a device or its components as described herein. For example, the operations of method 900 may be performed by a GPU as described with reference to FIGS. 4 through 7. In some examples, a device may execute a set of codes to control the functional elements of the device to perform the functions described below. Additionally or alternatively, the device may perform aspects of the functions described below using special-purpose hardware.

At 905 the device may identify a size of a cache of the device. The operations of 905 may be performed according to the methods described herein. In certain examples, aspects of the operations of 905 may be performed by a local memory component as described with reference to FIGS. 4 through 7.

At 910 the device may perform a visibility pass operation for the frame. The operations of 910 may be performed according to the methods described herein. In certain examples, aspects of the operations of 910 may be performed by a visibility stream processor as described with reference to FIGS. 4 through 7.

At 915 the device may determine dimensions of a frame based at least in part on the visibility pass operation. The operations of 915 may be performed according to the methods described herein. In certain examples, aspects of the operations of 915 may be performed by a frame geometry processor as described with reference to FIGS. 4 through 7.

At 920 the device may divide, based at least in part on the determined dimensions and the size of the cache, the frame into a first region and a second region that is separate from the first region. The operations of 920 may be performed according to the methods described herein. In certain examples, aspects of the operations of 920 may be performed by a frame segmentation manager as described with reference to FIGS. 4 through 7.

At 925 the device may divide the first region into a plurality of bins that each have a first vertical dimension and a first horizontal dimension. The operations of 925 may be performed according to the methods described herein. In certain examples, aspects of the operations of 925 may be performed by an internal region controller as described with reference to FIGS. 4 through 7.

At 930 the device may divide the second region into one or more bins, at least one bin of the one or more bins having a second vertical dimension that is greater than the first vertical dimension or a second horizontal dimension that is greater than the first horizontal dimension. The operations of 930 may be performed according to the methods described herein. In certain examples, aspects of the operations of 930 may be performed by a boundary region controller as described with reference to FIGS. 4 through 7.

At 935 the device may render the frame using the plurality of bins and the one or more bins. The operations of 935 may be performed according to the methods described herein. In certain examples, aspects of the operations of 935 may be performed by a rendering manager as described with reference to FIGS. 4 through 7.

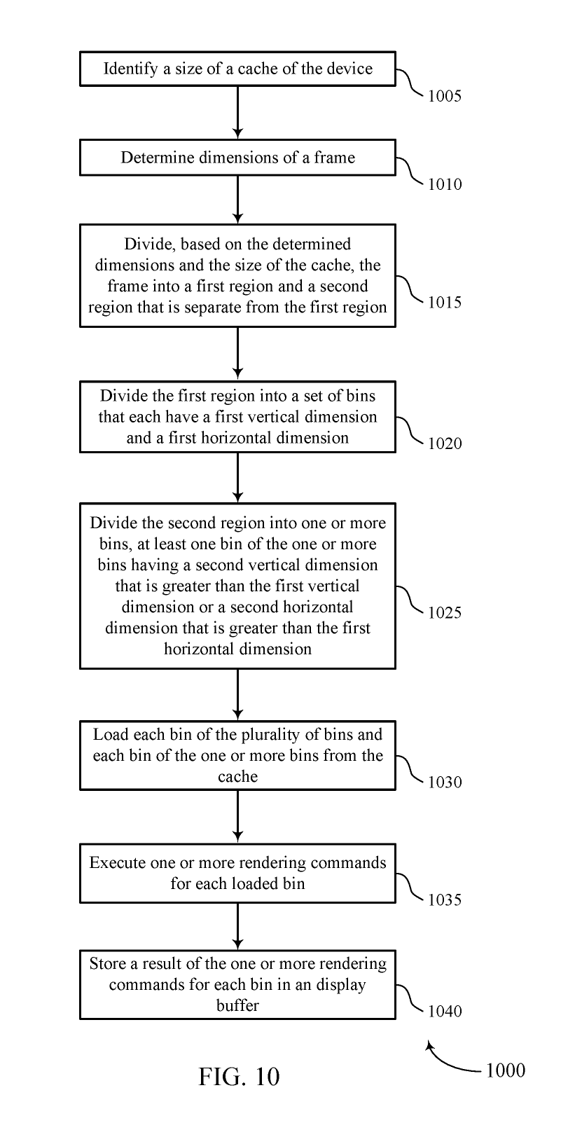

FIG. 10 shows a flowchart illustrating a method 1000 for efficient partitioning for binning layouts in accordance with aspects of the present disclosure. The operations of method 1000 may be implemented by a device or its components as described herein. For example, the operations of method 1000 may be performed by a GPU as described with reference to FIGS. 4 through 7. In some examples, a device may execute a set of codes to control the functional elements of the device to perform the functions described below. Additionally or alternatively, the device may perform aspects of the functions described below using special-purpose hardware.

At 1005 the device may identify a size of a cache of the device. The operations of 1005 may be performed according to the methods described herein. In certain examples, aspects of the operations of 1005 may be performed by a local memory component as described with reference to FIGS. 4 through 7.

At 1010 the device may determine dimensions of a frame. The operations of 1010 may be performed according to the methods described herein. In certain examples, aspects of the operations of 1010 may be performed by a frame geometry processor as described with reference to FIGS. 4 through 7.

At 1015 the device may divide, based at least in part on the determined dimensions and the size of the cache, the frame into a first region and a second region that is separate from the first region. The operations of 1015 may be performed according to the methods described herein. In certain examples, aspects of the operations of 1015 may be performed by a frame segmentation manager as described with reference to FIGS. 4 through 7.

At 1020 the device may divide the first region into a plurality of bins that each have a first vertical dimension and a first horizontal dimension. The operations of 1020 may be performed according to the methods described herein. In certain examples, aspects of the operations of 1020 may be performed by an internal region controller as described with reference to FIGS. 4 through 7.

At 1025 the device may divide the second region into one or more bins, at least one bin of the one or more bins having a second vertical dimension that is greater than the first vertical dimension or a second horizontal dimension that is greater than the first horizontal dimension. The operations of 1025 may be performed according to the methods described herein. In certain examples, aspects of the operations of 1025 may be performed by a boundary region controller as described with reference to FIGS. 4 through 7.

At 1030 the device may load each bin of the plurality of bins and each bin of the one or more bins from the cache. The operations of 1030 may be performed according to the methods described herein. In certain examples, aspects of the operations of 1030 may be performed by a rendering manager as described with reference to FIGS. 4 through 7.

At 1035 the device may execute one or more rendering commands for each loaded bin. The operations of 1035 may be performed according to the methods described herein. In certain examples, aspects of the operations of 1035 may be performed by a rendering manager as described with reference to FIGS. 4 through 7.

At 1040 the device may store a result of the one or more rendering commands for each bin in a display buffer. The operations of 1040 may be performed according to the methods described herein. In certain examples, aspects of the operations of 1040 may be performed by a rendering manager as described with reference to FIGS. 4 through 7.

It should be noted that the methods described above describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for rendering, comprising:
a processor;
memory in electronic communication with the processor; and
instructions stored in the memory and executable by the processor to cause the apparatus to:
identify a size of a cache of the apparatus;
determine dimensions of a frame;
divide, based at least in part on the determined dimensions and the size of the cache, the frame into a first region and a second region that is separate from the first region;
divide the first region into a plurality of bins that each have a first vertical dimension and a first horizontal dimension;
divide the second region into one or more bins, at least one bin of the one or more bins having a second vertical dimension that is greater than the first vertical dimension or a second horizontal dimension that is greater than the first horizontal dimension; and
render the frame using the plurality of bins and the one or more bins.

2. The apparatus of claim 1, wherein the instructions to divide the second region into the one or more bins are executable by the processor to cause the apparatus to: divide the second region into a first bin having the second vertical dimension and a second bin having the second horizontal dimension.

3. The apparatus of claim 2, wherein the second vertical dimension is different from the second horizontal dimension.

4. The apparatus of claim 1, wherein the instructions to divide the second region into the one or more bins are executable by the processor to cause the apparatus to:
divide the second region into a first bin having the second vertical dimension and a second bin having the second vertical dimension; or
divide the second region into a third bin having the second horizontal dimension and a fourth bin having the second horizontal dimension; or
both.

5. The apparatus of claim 1, wherein the instructions to divide the second region into the one or more bins are executable by the processor to cause the apparatus to:
divide the second region into a first bin having the second vertical dimension and a second bin, wherein a sum of a vertical dimension of the second bin and the second vertical dimension is greater than or equal to a total vertical dimension of the frame.

6. The apparatus of claim 1, wherein the instructions to divide the second region into the one or more bins are executable by the processor to cause the apparatus to:
divide the second region into a first bin having the second horizontal dimension and a second bin, wherein a sum of a horizontal dimension of the second bin and the second horizontal dimension is greater than or equal to a total horizontal dimension of the frame.

7. The apparatus of claim 1, wherein the instructions to divide the frame into a first region and a second region are executable by the processor to cause the apparatus to:
classify the first region as an internal region and the second region as an edge region that is directly adjacent to the internal region on at least two sides.

8. The apparatus of claim 1, wherein the instructions to divide the second region into the one or more bins are executable by the processor to cause the apparatus to:
divide the second region in a vertical direction, a horizontal direction, or both to increase a utilization of the cache.

9. The apparatus of claim 1, wherein the instructions are further executable by the processor to cause the apparatus to:
divide the frame into the first region and the second region occurs concurrently with dividing the first region into the plurality of bins, or dividing the second region into the one or more bins, or both.

10. The apparatus of claim 1, wherein each bin of the one or more bins has a size that is smaller than the size of the cache.

11. The apparatus of claim 1, wherein the instructions to divide the first region into the plurality of bins are executable by the processor to cause the apparatus to:
divide the first region such that a size of each of the plurality of bins after the dividing is less than or equal to the size of the cache.

12. The apparatus of claim 1, wherein a size of the first region is greater than a size of the second region.

13. The apparatus of claim 1, wherein the instructions are further executable by the processor to cause the apparatus to:
perform a visibility pass operation for the frame, wherein the determining the dimensions of the frame is based at least in part on the visibility pass operation.

14. The apparatus of claim 1, wherein the instructions to render the frame are executable by the processor to cause the apparatus to:
load each bin of the plurality of bins and each bin of the one or more bins from the cache;
execute one or more rendering commands for each loaded bin; and
store a result of the one or more rendering commands for each bin in a display buffer.

15. The apparatus of claim 1, wherein the instructions to render the frame are executable by the processor to cause the apparatus to:
execute one or more rendering commands to render at least a subset of the one or more bins directly on a system memory of the apparatus.

16. The apparatus of claim 1, wherein the dimensions of the frame are equal to a size of the first region plus a size of the second region.

17. A method for rendering at a device, comprising:
identifying a size of a cache of the device;
determining dimensions of a frame;
dividing, based at least in part on the determined dimensions and the size of the cache, the frame into a first region and a second region that is separate from the first region;
dividing the first region into a plurality of bins that each have a first vertical dimension and a first horizontal dimension;
dividing the second region into one or more bins, at least one bin of the one or more bins having a second vertical dimension that is greater than the first vertical dimension or a second horizontal dimension that is greater than the first horizontal dimension; and
rendering the frame using the plurality of bins and the one or more bins.

18. The method of claim 17, wherein dividing the second region into the one or more bins comprises:
dividing the second region into a first bin having the second vertical dimension and a second bin having the second horizontal dimension.

19. A non-transitory computer-readable medium storing code for rendering, the code comprising instructions executable by a processor to:
identify a size of a cache of a device;
determine dimensions of a frame;
divide, based at least in part on the determined dimensions and the size of the cache, the frame into a first region and a second region that is separate from the first region;
divide the first region into a plurality of bins that each have a first vertical dimension and a first horizontal dimension;
divide the second region into one or more bins, at least one bin of the one or more bins having a second vertical dimension that is greater than the first vertical dimension or a second horizontal dimension that is greater than the first horizontal dimension; and
render the frame using the plurality of bins and the one or more bins.

20. The non-transitory computer-readable medium of claim 19, wherein the instructions to divide the second region into the one or more bins are executable by the processor to:
divide the second region into a first bin having the second vertical dimension and a second bin having the second horizontal dimension.
